(19) United States
(12) Patent Application Publication
(10) Pub. No.: US 2013/0002220 A1
(43) Pub. Date: Jan. 3, 2013

(54) SEMICONDUCTOR INTEGRATED CIRCUIT FOR REGULATOR

(75) Inventor: Akihiro TERADA, Ebina-shi (JP)

(73) Assignee: MITSUMI ELECTRIC CO., LTD., Tama-shi (JP)

(21) Appl. No.: 13/537,368

(22) Filed: Jun. 29, 2012

(30) Foreign Application Priority Data
Jun. 29, 2011 (JP) 2011-143659

(51) Int. Cl. G05F 1/46

(52) U.S. Cl. 323/282

(57) ABSTRACT

Disclosed is a semiconductor integrated circuit for regulator including: a control transistor; a voltage divider circuit generating a feedback voltage proportional to an output voltage; a control circuit controlling the control transistor based on difference between the feedback voltage and a reference voltage; and a terminal through which an output voltage switching control signal is received, and being configured to switch the output voltage into a first voltage or into a second voltage lower than the first voltage, by varying division ratio in the voltage divider circuit in response to the signal. The semiconductor integrated circuit further includes: a discharging transistor between the output terminal and the ground; and a circuit outputting a signal for keeping the discharging transistor turned on over a period from change of the signal to fall of the output voltage from the first voltage down to the second voltage.

### CROSS-REFERENCE TO RELATED APPLICATION

The present U.S. patent application claims a priority under the Paris Convention of Japanese patent application No. 2011-143659 filed on Jun. 29, 2011, which shall be a basis of correction of an incorrect translation, and is incorporated by reference herein.

### BACKGROUND OF THE INVENTION

1. Field of the Invention

The present invention relates to a DC power supply and further relates to a voltage regulator which converts DC voltage, and more specifically to a technique effectively applicable to a semiconductor integrated circuit (regulator IC) which configures a series regulator (including low-dropout regulator (LDO)) having an output voltage switching function.

2. Description of Related Art

In DC power supply, there is a demand of switching of output voltage level, for the purpose of suppressing degradation in characteristics of a device which serves as a load to be supplied with electric power. One known control semiconductor integrated circuit composing a conventional series regulator has, as illustrated in FIG. 4, a control terminal through which an output voltage switching control signal CV is received, and is configured to switch the output voltage level depending on a state (high or low) of the input signal CV at the control terminal.

The series regulator given the switching function illustrated in FIG. 4 has bleeder resistors R1, R2, a resistor R3 and a transistor M2. The bleeder resistors R1, R2 divide output voltage Vₒᵤₜ and supply a feedback voltage V_{FB} to an error amplifier AMP. The resistor R3 and the transistor M2 are connected in series, and in parallel with the resistor R2, out of the bleeder resistors R1, R2. By turning the transistor M2 on or off using the output voltage switching control signal CV, the voltage division ratio by the bleeder resistors may be varied, and thereby the output voltage level may be switched.

The regulator given the switching function illustrated in FIG. 4, however, allows discharge of an output capacitor Co only through the load, so that it takes a long time to bring the output voltage Vₒᵤₜ from a high level down to a low level, proving poor switching response characteristics. One possible solution therefor is, as illustrated in FIG. 5, to provide a resistor Ro in parallel with the output capacitor Co, so as to improve the switching response characteristics.

However, in the regulator illustrated in FIG. 5, the time necessary for the output voltage Vₒᵤₜ to reach a switched level varies depending on the value of the resistor Ro or state of a device which serves as the load, as illustrated in FIG. 2C. In addition, since current constantly flows through the resistor Ro in the general operation, so that wasteful current will increase.

Japanese Laid-Open Patent Publication No. 2010-191885 discloses a series regulator aimed at improving the transient response characteristics, which has a switching transistor for bypassing current, provided in parallel with the bleeder resistors. In the series regulator disclosed in Japanese Laid-Open Patent Publication No. 2010-191885, the switching transistor is provided in parallel with the entire bleeder resistors, rather than in parallel with either one of the bleeder resistors. In addition, the invention disclosed in Japanese Laid-Open Patent Publication No. 2010-191885 is aimed at improving the transient response characteristics in case of abrupt changes in the output voltage, rather than improving the transient response characteristics when the output voltage is switched.

### SUMMARY OF THE INVENTION

The present invention was conceived in consideration of the situation described in the above, and an object of which is to provide a semiconductor integrated circuit used for regulators, capable of improving the transient response characteristics when the output voltage is switched, without increasing a wasteful current.

For the purpose of attaining the above-described objects, according to the present invention, there is provided a semiconductor integrated circuit for regulator including: a control transistor connected between an input terminal and an output terminal; a voltage divider circuit which generates a feedback voltage proportional to an output voltage; a control circuit which controls the control transistor based on difference between the feedback voltage and a predetermined reference voltage; and a terminal through which an output voltage switching control signal is received from the external, and being configured to switch the output voltage into a first voltage or into a second voltage lower than the first voltage, by varying division ratio in the voltage divider circuit in response to an output voltage switching control signal. The semiconductor integrated circuit further comprising: a discharging transistor which is connected between the output terminal and the ground; and a circuit for controlling output fall during switching, which outputs a signal for keeping the discharging transistor turned on over a period from change of the control signal to fall of the output voltage from the first voltage down to the second voltage, based on difference between the feedback voltage and the reference voltage.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a circuit diagram illustrating a control IC used in a series regulator of this embodiment;

FIG. 2A is a characteristic diagram illustrating gate control signal (1/CV) of the MOS transistor M2 of this embodiment;

FIG. 2B is a characteristic diagram illustrating output voltage of the series regulator of this embodiment;

FIG. 2C is a characteristic diagram illustrating output voltage of a conventional series regulator;

FIG. 3 is a circuit diagram illustrating a modified example of the control IC used in the series regulator illustrated in FIG. 1;

FIG. 4 is a circuit diagram illustrating a control IC used in a conventional series regulator having an output voltage switching function; and

FIG. 5 is a circuit diagram illustrating a series regulator control IC improved in the output voltage response characteristics during switching of output voltage.

### DESCRIPTION OF THE PREFERRED EMBODIMENTS

Preferred embodiments of the present invention will be explained below, referring to the attached drawings.

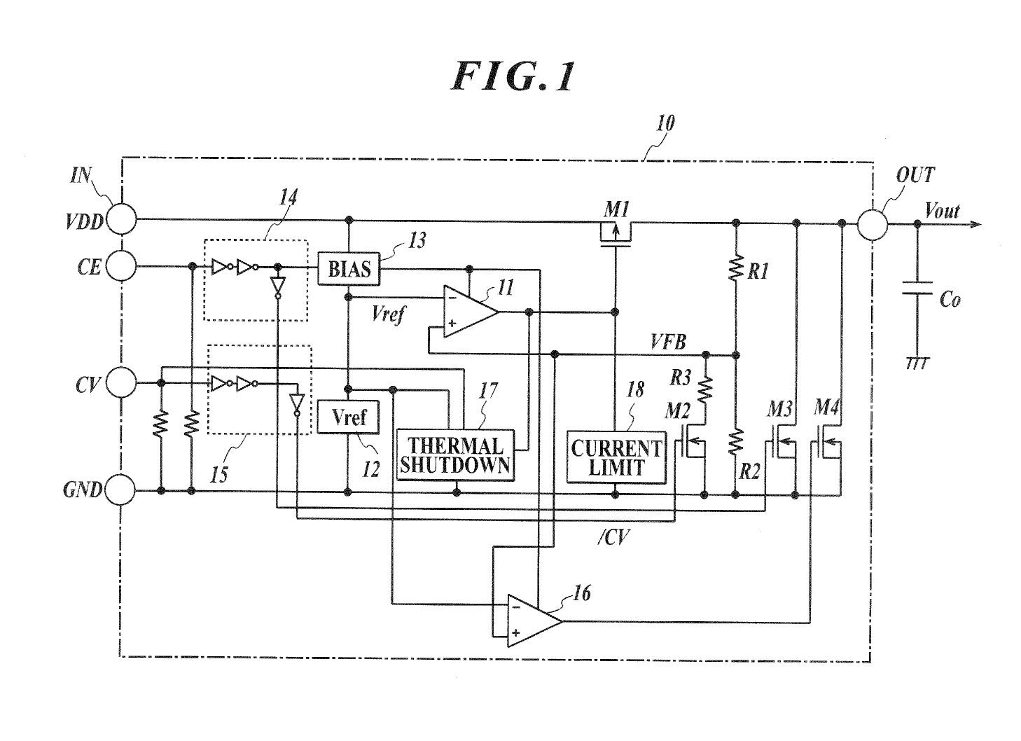

FIG. 1 illustrates one embodiment of a series regulator (including LDO) applied by the present invention. Although not specifically limited, elements composing a circuit surrounded by a one-dot chain line in FIG. 1 are formed on a single semiconductor chip, so as to configure a semiconductor integrated circuit 10 for controlling the regulator (referred to as regulator IC, hereinafter).

The regulator IC 10 of this embodiment has a voltage input terminal IN, an output terminal OUT, a voltage control transistor M1, bleeder resistors R1, R2, a resistor R3, a MOS transistor M2, an error amplifier 11, a reference voltage circuit 12, a bias circuit 13, a starting control circuit 14, and a logic circuit 15.

The voltage input terminal IN is applied with DC voltage VDD from an unillustrated DC voltage source. The voltage control transistor M1 is connected between the voltage input terminal IN and the output terminal OUT. The voltage control transistor M1 is composed of a P-channel MOSFET (metal oxide semiconductor field effect transistor, referred to as MOS transistor, hereinafter).

The bleeder resistors R1, R2 are connected between the output terminal OUT and a ground terminal GND. The bleeder resistors R1, R2 divide the output voltage Vₒᵤₜ. Voltage V_{FB} produced by voltage division by the bleeder resistors R1, R2 is fed back to a non-inverting input terminal of the error amplifier 11. Output of the error amplifier 11 is fed to the gate terminal of the voltage control transistor M1.

The error amplifier 11 controls the voltage control transistor M1, corresponding to potential difference between the feedback voltage V_{FB} and a reference voltage V_{ref}. Resistance ratio of the bleeder resistors R1, R2 is set so as to adjust the output voltage Vₒᵤₜ to a desired value. The series regulator of this embodiment acts so as to keep the output voltage Vₒᵤₜ constant, by the feedback control described in the above. The output terminal OUT is externally attached with an output capacitor Co which stabilizes the output voltage Vₒᵤₜ.

The reference voltage circuit 12 generates the reference voltage V_{ref}. The reference voltage circuit 12 may be configured by using a constant voltage circuit composed of a Zener diode. Alternatively, the reference voltage circuit 12 may be configured typically by using a reference voltage generation circuit which contains a depletion-mode MOS transistor as a constant current source, and an enhancement-mode MOS transistor connected thereto in series.

The bias circuit 13 feeds bias current to the reference voltage circuit 12 and the error amplifier 11.

The starting control circuit 14 is configured typically by an inverter. The starting control circuit 14 brings the bias circuit 13 into an active state, in response to a chip enable signal CE. The chip enable signal CE is an externally-fed signal for turning the chip on or off.

The regulator IC 10 of this embodiment has a terminal through which the chip enable signal CE is received from the external, and a terminal through which the output voltage switching control signal CV is received from the external.

The resistor R3 and the MOS transistor M2 are connected in series, and is connected in parallel with the resistor R2, out of the bleeder resistors R1, R2. By turning the MOS transistor M2 on or off, the voltage division ratio by the bleeder resistors may be varied, and thereby the level of output voltage Vₒᵤₜ may be switched.

The logic circuit 15 is configured by an inverter and so forth. The logic circuit 15 generates an internal signal of the chip, in response to the output voltage switching control signal CV. The control signal output from the logic circuit 15 is fed to the gate terminal of the MOS transistor M2. When the output voltage switching signal CV is at a high level, the MOS transistor M2 turns off, the voltage division ratio of the output voltage is determined by the bleeder resistors R1, R2, and thereby the output voltage Vₒᵤₜ is kept at the low level. On the other hand, when the output voltage switching control signal CV is at a low level, the MOS transistor M2 turns on, the voltage division ratio of the output voltage is determined by the resistance of the resistor R1 and a combined resistance of the resistors R2 and R3, and thereby the output voltage Vₒᵤₜ shifts from the low level to the high level.

The regulator IC 10 of this embodiment is further provided with N-channel MOS transistors M3 and M4, and a voltage comparator circuit 16.

The N-channel MOS transistors M3 and M4 are connected in parallel, between the output terminal OUT and the ground point GND.

The gate terminal of the MOS transistor M3 is fed with a control signal from the starting control circuit 14. When the chip enable signal CE changes from the high level to the low level so as to turn the chip off, the MOS transistor M3 turns on to discharge the output capacitor Co, and swiftly brings the output voltage Vₒᵤₜ down to the ground potential (0 V).

The gate terminal of the MOS transistor M4 is fed with an output signal of the voltage comparator circuit 16.

The voltage comparator circuit 16 compares the feedback voltage V_{FB} and the reference voltage V_{ref}. A differential amplifier circuit intentionally added with offset is used as the voltage comparator circuit 16 of this embodiment. Note that the word “intentionally” herein is used to exclude any offset which naturally occurs due to process variation.

Methods of adding offset to the differential amplifier circuit typically includes a method of making difference in the ratio of gate width W and gate length L of the differential transistors; a method of making difference in the resistance value of the elements which serve as loads of the differential transistors; and a method of connecting a resistor to an input of only one of the differential transistors.

When the output voltage switching signal CV changes from the low level to the high level, the MOS transistor M2 turns off. The feedback voltage V_{FB} then becomes higher than the reference voltage V_{ref}, the output signal of the voltage comparator circuit 16 changes to the high level, the MOS transistor M4 turns on, and the output capacitor Co starts to discharge.

On the other hand, when the MOS transistor M2 turns off, the output voltage Vₒᵤₜ falls from the high level V1 down to the low level V2. When the output voltage Vₒᵤₜ falls down to the low level V2, the feedback voltage V_{FB} falls down to the reference voltage V_{ref}, the output signal of the voltage comparator circuit 16 falls down to the low level, and thereby the MOS transistor M4 turns off.

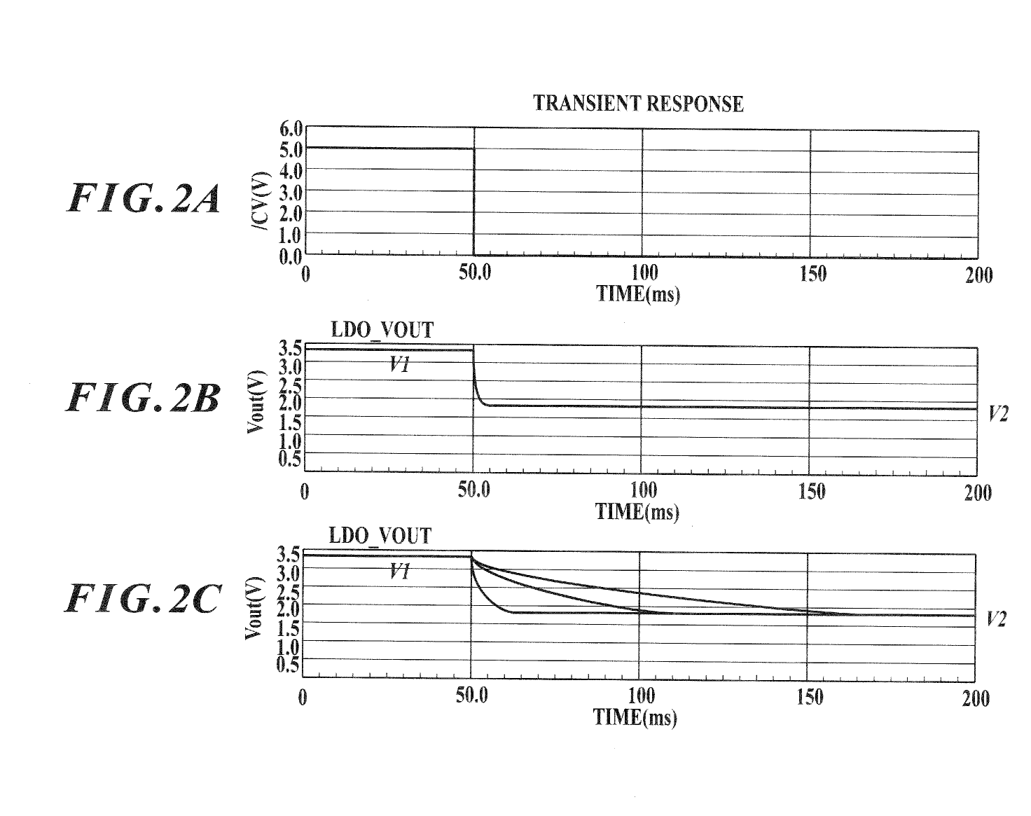

FIG. 2A is a characteristic diagram illustrating gate control signal (1/CV) of the MOS transistor M2 of this embodiment, and FIG. 2B is a characteristic diagram illustrating the output voltage of the series regulator of this embodiment.

When the output voltage switching control signal CV changes from the low level to the high level, and thereby when the gate control voltage for the MOS transistor M2 output from the logic circuit 15 shifts from the high level down to the low level as illustrated in FIG. 2A, the output voltage Vₒᵤₜ may be brought down swiftly to the target low level V2 within a predetermined short time, irrespective of the state of load, as illustrated in FIG. 2B.

On the other hand, when the output voltage switching control signal CV changes from the high level down to the low level, the feedback voltage V_{FB} temporarily shifts to the low level, whereas the output signal of the voltage comparator circuit 16 remains unchanged, so that the MOS transistor M4 will not turn on. Since the voltage comparator circuit 16 is configured by using the differential amplifier circuit intentionally added with offset, so that the MOS transistor M4 will not turn on even if the feedback voltage V_{FB} varies depending on changes in load in the steady state.

While the regulator IC 10 of this embodiment additionally has a thermal shut-down circuit 17 and a current limit circuit 18, the present invention is not limited to those having these additional components.

The thermal shut-down circuit 17 has a temperature detection circuit which terminates operation of the circuit when the chip temperature was detected to exceed a predetermined temperature. The thermal shut-down circuit 17 is disclosed typically in Japanese Laid-Open Patent Publication No. 2007-318028.

The current limit circuit 18 protects the element from over-current, by reducing the output current while lowering the output voltage Vₒᵤₜ, when the output current increased and reached a predetermined value due to short-circuiting of the load or the like. The current limit circuit 18 is disclosed, for example, in Japanese Laid-Open Patent Publication No. 2008-052516. The thermal shut-down circuit 17 and the current limit circuit 18 will not be detailed herein, since the both are publicly known.

As described in the above, the discharging transistors M3, M4 do not conduct electric current in the normal operation, but temporality turn on to swiftly bring down the output voltage Vₒᵤₜ, when the output voltage switching control signal CV varies and the output voltage Vₒᵤₜ changes from the high level V1 down to the low level V2, so that the transient response characteristics during switching of the output voltage may be improved without increasing wasteful current in the steady state.

In addition, by intentionally adding offset to the voltage comparator circuit 16, a signal which temporarily turns the discharging transistor M4 during switching of the output voltage may be generated by a relatively simple circuit, so that the transient response characteristics during switching of the output voltage may be improved without increasing so much the circuit scale.

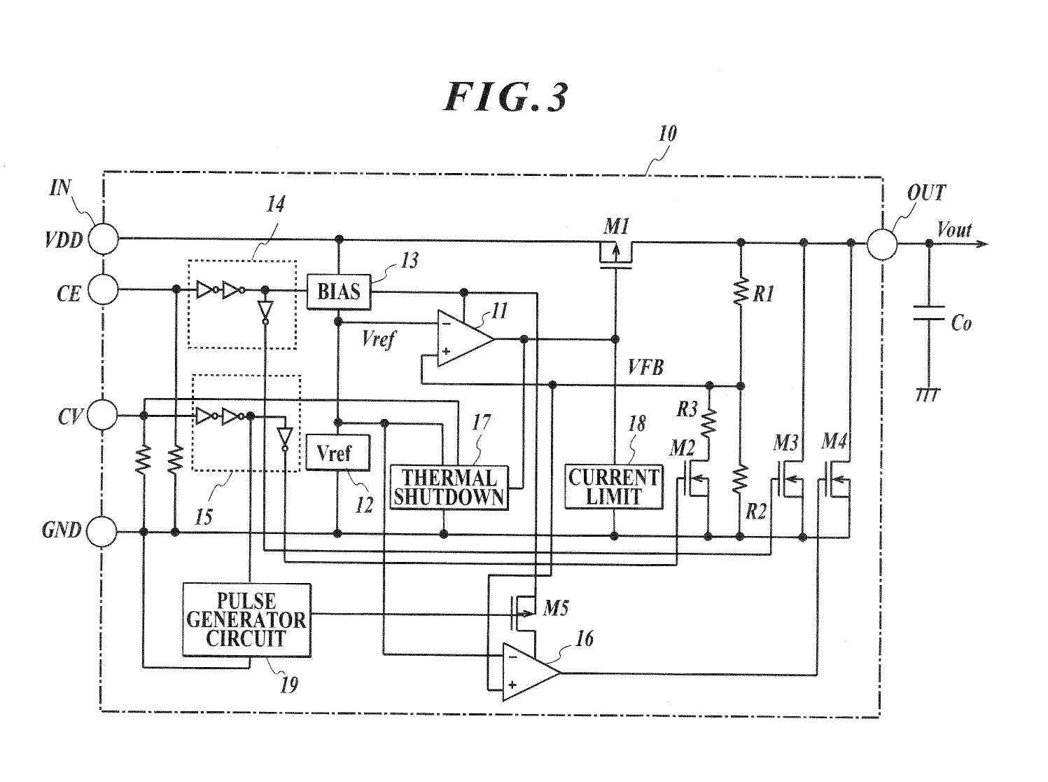

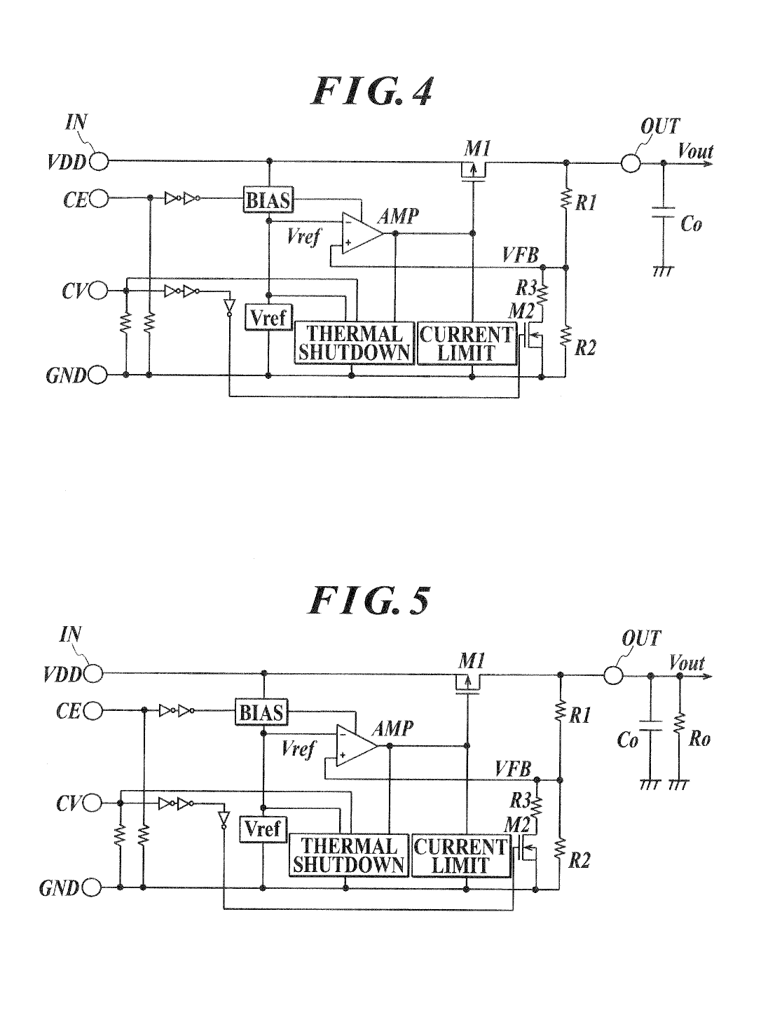

FIG. 3 illustrates a modified example of the series regulator IC of the embodiment illustrated in FIG. 1.

In this modified example, a P-channel MOS transistor M5, and a pulse generator circuit 19 are additionally provided. The P-channel MOS transistor M5 is provided between the source voltage terminal of the voltage comparator circuit 16 and the bias circuit 13, and functions as a power switch of the voltage comparator circuit 16. The pulse generator circuit 19 detects change of the output voltage switching control signal CV from the low level up to the high level, and generates an one-shot pulse having a predetermined width. When the P-channel MOS transistor M5 is turned on by the one-shot pulse generated by the pulse generator circuit 19, operating current temporarily flows through the voltage comparator circuit 16, and the voltage comparator circuit 16 starts to operate.

By temporarily operating the voltage comparator circuit 16, the modified example may reduce the current consumption as compared with the regulator IC illustrated in FIG. 1. Another possible configuration may be such as implementing on/off control of a power source of the voltage comparator circuit 16, making use of the one-shot pulse generated by the pulse generator circuit 19, rather than providing the MOS transistor M5 as the power switch of the voltage comparator circuit 16.

It is still also possible to provide a CR time constant circuit for specifying the pulse width of the one-shot pulse, to the pulse generator circuit 19. Alternatively, an external terminal allowing connection of a capacitor, which composes the CR time constant circuit and assumed as an externally attached element, may be provided to the regulator IC 10, so as to allow the user to arbitrarily set the pulse width by appropriately selecting the capacitor, or to set the operating time of the voltage comparator circuit 16.

In the configuration provided with the pulse-width-adjustable pulse generator circuit, the voltage comparator circuit 16 is omissible, phase of the output of the pulse generator circuit may be inverted, and the MOS transistor M4 for discharging may directly be turned on or off by the phase-inverted output. In this case, a resistor may be provided in series with the MOS transistor M4, so as to adjust the fall rate of the output voltage Vₒᵤₜ based on a resistance value of the resistor.

While the invention accomplished by the present inventor has been detailed referring to the embodiments, the present invention is not limited thereto. For example, while the embodiments in the above adopted a separate configuration of the MOS transistor M3 which is directed to drop the output voltage Vₒᵤₜ in the off time of the chip, and the MOS transistor M4 which is directed to drop the output voltage Vₒᵤₜ in the switching of output voltage, an alternative configuration may be such as providing these transistors as a common transistor, and also providing an OR gate which is designed to implement the OR operation of the output of the logic circuit 15 and the output of the voltage comparator circuit 16, so as to allow on/off control of the common transistor based on the output of the OR gate.

Provision of the OR gate may otherwise increase the number of elements which compose the circuit. However, in contrast to that the transistors M3, M4 which are designed to allow discharge through the output terminal need a relatively large size for the configuration, the OR gate needs only small-sized elements since the load of the OR gate is only a gate capacitance of the MOS transistor. Accordingly, in the configuration having the MOS transistors M3 and M4 replaced by a single element, the total area occupied by the circuit may be reduced.

While the embodiments described in the above used a MOS transistors as the control transistor for controlling the output voltage, the present invention is also applicable to a regulator which uses a bipolar transistor as the control transistor.

While the embodiments described in the above used an offset-added differential amplifier circuit as the voltage comparator circuit 16 for controlling the MOS transistor M4 for discharge, another possible configuration is such as using a general differential amplifier circuit having no offset, and instead feeding the feedback voltage to the differential amplifier circuit after shifted the feedback voltage by a predetermined potential corresponding to the offset.

In addition, while the description in the above dealt with the case where the present invention was applied to the series regulator IC, the present invention is not limited thereto, and is also applicable to a charging control IC which configures a charger for secondary batteries.

What is claimed is:

1. A semiconductor integrated circuit for regulator comprising:
a control transistor connected between an input terminal and an output terminal;
a voltage divider circuit which generates a feedback voltage proportional to an output voltage;
a control circuit which controls the control transistor based on difference between the feedback voltage and a predetermined reference voltage; and
a terminal through which an output voltage switching control signal is received from the external,
and being configured to switch the output voltage into a first voltage or into a second voltage lower than the first voltage, by varying division ratio in the voltage divider circuit in response to the output voltage switching control signal,
wherein the semiconductor integrated circuit further comprises:
a discharging transistor which is connected between the output terminal and the ground; and
a circuit for controlling output fall during switching, which outputs a signal for keeping the discharging transistor turned on over a period from change of the output voltage switching control signal to fall of the output voltage from the first voltage down to the second voltage, based on difference between the feedback voltage and the reference voltage.

2. The semiconductor integrated circuit for regulator of claim 1,
wherein the circuit for controlling output fall during switching is a differential amplifier circuit intentionally added with offset.

3. The semiconductor integrated circuit for regulator of claim 2, further comprising:
a pulse generator circuit which generates an one-shot pulse having a predetermined pulse width, when the output voltage switching control signal changes,
being configured to allow operating current to temporarily flow through the differential amplifier circuit, triggered by the one-shot pulse.

4. The semiconductor integrated circuit for regulator of claim 1, further comprising:
a second discharging transistor connected between the output terminal and the ground; and
an external terminal through which an actuating/non-actuating control signal for actuating or non-actuating a chip is received from the external,
being configured to turn the second discharging transistor on, when the actuating/non-actuating control signal shifts to a signal for non-actuating the chip.

5. The semiconductor integrated circuit for regulator of claim 1, further comprising:
an external terminal through which an actuating/non-actuating control signal for actuating or non-actuating a chip is received from the external,
being configured to turn the discharging transistor on,
over a period from change of the control signal to fall of the output voltage from the first voltage down to the second voltage, based on comparison between the feedback voltage and the reference voltage, and/or
when the actuating/non-actuating control signal shifts to a signal for non-actuating the chip.
